(19) United States
(12) Patent Application Publication
(10) Pub. No.: US 2004/0164099 A1
(43) Pub. Date: Aug. 26, 2004

(54) Nebulizer for applying liquids on the surface of the eye or the ocular connective tissue

(75) Inventors: Michael Diestelhorst, Koeln (DE); Isolde Martin, Ingelheim (DE); Bernd Zierenberg, Bingen (DE); Dieter Hochrainer, Schmallenberg (DE)

Correspondence Address: BOEHRINGER INGELHEIM CORPORATION, 900 RIDGEBURY ROAD, P. O. BOX 368, RIDGEFIELD, CT, 06877, US

(73) Assignee: Boehringer Ingelheim Pharma GmbH & Co., KG, Ingelheim (DE)

(21) Appl. No.: 10/739,484

(22) Filed: Dec. 18, 2003

(30) Foreign Application Priority Data
Jun. 26, 2002 (WO) PCT/EP02/07042
Jun. 29, 2001 (DE) DE 101 31 174

(51) Int. Cl. B67D 5/58

(52) U.S. Cl. 222/190; 222/321.7

(57) ABSTRACT

The present invention relates to atomizers for administering preservative-free liquids to the cornea or conjunctiva of the eye, with special eye adapters for atomizers and the use of atomizers for ophthalmological administration. The atomizers according to the invention are free from propellant gas.

The present invention relates to atomisers for applying preservative-free liquids to the cornea of the eye or to the conjunctival tissue, special eye adapters for atomizers and the use of atomizers for ophthalmological administration. The atomizers according to the invention are free from propellant gas.

### PRIOR ART

For treating dry eyes, for moistening the surface of the eye for contact lens wearers, for numerous eye diseases or methods of investigating the eye it is usual to administer medicaments in the form of an aqueous formulation as eye drops. For this form of administration, liquid dispensers have been developed in which the formulation is supplied from a storage bottle through a dropper, for example (dropper bottles or EDO-Ophthiols). The aqueous formulation usually flows out of the dropper opening as a result of manual pressure being applied to the compressible storage bottle. First, a drop forms on the opening, which does not break away from the dropper and drop into the eye until a certain relationship is reached between the size of the dropper opening, the surface tension and the weight of the drop. Usually, aqueous eye drops have a volume of about 0.05 ml.

This method of dropping liquids onto the eye has various disadvantages. On the one hand, not all patients find it easy to administer drops of liquid into their own eyes. This is partly because they have to lean their head back (recline the head) and then let the drop fall into the eye from above. Children and old people in particular find this very difficult.

In addition, it happens occasionally that a patient will accidentally stick the applicator of the dropper bottle into their eye. A further disadvantage is that the formulation administered is initially only applied to one point on the cornea, which feels unpleasant, not only because of the local pressure produced on the surface of the eye.

Often, the patients themselves cannot tell whether they have successfully administered the prescribed amount of eye drops or not. As a rule a patient only realises whether any liquid has reached the target organ when an excess of the formulation comes out of the eye and is noticed, for example, either by tasting it or as liquid on the cheeks. However, once this stage has been reached, an excessive dose has already been given, which may lead to unwanted systemic side effects.

In connection with this, it is important to note that the surface of the eye is coated with about 7 microlitres of a film of liquid. Any application of an additional liquid consequently causes some of the total liquid on the eye to flow away through the tear duct. This naturally occurs particularly when larger amounts of liquid, such as e.g. 40 microlitres or more of eye drops are applied. If a pharmacologically effective liquid enters the tear duct, it can be absorbed systemically by the body, i.e. the pharmacologically active ingredients are absorbed directly by the body. This may lead to allergic or toxicological effects. In conventional applications about 80% of the liquid administered is displaced out of the eye and some of it enters the tear duct.

Another disadvantage is that during the instilling of the drops the patient has to consciously fight their blink reflex. If they do not manage to do so, the formulation is delivered not to the eye but to the eyelid and further drops have to be given, which may in turn lead to overdosing with the consequences described above and cause undesirable systemic side effects.

Another disadvantage of this method is that there may be short-term irritation of the eyes at the site where the drops are instilled.

The conventional application devices are also not protected against the entry of germs into the formulation for administration, which means that preservatives have to be added to the formulations. Preservatives may lead to chronic inflammation of the conjunctiva or the underlying Tenon's membrane in long-term or chronic use. There may be morphological changes in this tissue, which are a major drawback particularly in operations, as the wound healing process is disrupted and/or scarring may occur.

U.S. Pat. No. 5,588,564 discloses a pump spray provided with an adapter for administering a spray jet to the eye. As the spray duration of this system is short, there is a danger that the solution will not be sprayed onto the eye but onto the eyelid, as a result of the blink reflex. Neither the pump spray nor the adapter has any germicidally acting means.

U.S. Pat. No. 5,921,444 discloses a spray device with a fitting for administering a liquid to an eye. The disadvantages of this system are similar to those described above.

WO 96/00050 discloses an applicator for applying liquids to an eye, wherein the spray device is located within a housing one side of which is constructed so that it can fit round an eye. The aerosol droplets produced with the device have a diameter of at least 20 micrometres. The spray duration of this system is less than 1/20^{th} of a second (page 13), which has the disadvantages described above.

EP 0911056 discloses an atomizer for placing over an eye with an adapter which has a shutter or deflector plate positioned so that the spray jet does not strike the cornea directly. However, on the one hand a protector of this kind will become dirty very quickly and is difficult to clean and on the other hand it militates against exact and reproducible metering.

### DESCRIPTION OF THE INVENTION

Thus, the problem on which the present invention is based is to apply aqueous solutions or ophthalmologically effective formulations to the surface of the eye in such a way as to reduce the local irritation of one area of the cornea compared with conventional methods of applying eye drops.

Another problem is to develop a process with which eye drops can be administered in a manner which is more pleasant for the user than is known from the prior art.

Another problem is to develop a process in which the liquid to be administered can be applied uniformly over the eye.

Yet another objective is to minimise the risk of injury to the eye during application of the eye drops.

A further objective is to provide an applicator for ophthalmological liquids wherein there is no need to use preservatives such as EDTA or benzalkonium chloride in the solution for application.

The present invention solves this problem by providing atomizers which convert the formulation to be applied through a nozzle into a spray mist with small particle sizes and bring this spray mist into contact with the surface of the eye, the atomizers having means for suppressing germ production.

These atomizers comprise, close to the nozzle from which the spray mist emerges, an adapter which fixes the spacing between the nozzle and the eye and prevents the spray mist from being blown away by the wind.

### DETAILED DESCRIPTION OF THE INVENTION

According to the invention the eye applicators used may be atomisers fitted with an adapter for directing the spray mist towards the eye. All kinds of atomisers may be used which meet the criteria set out above and comprise means for preventing biological germs from colonising the solution for application.

Examples of atomisers include: atomisers known from propellant-free pulmonary inhalation therapy or intranasal application, such as for example:

a) Atomisers consisting of a compressible plastic bottle with dropper,

b) Atomisers consisting of glass, metal or plastic bottles with pump attachments, preferably those known from WO 97/18902, to which reference is hereby made in its entirety.

These atomisers must have means for preventing the production of germs in the storage bottle. Such means include microbiological filters which are mounted in the passages through which air is able to penetrate into the metering chamber or storage bottle. The dimensions of these filters are such that they will not let any biological germs through but will allow air to pass through. Other means include for example the application of germicidal or oligodynamic substances to at least some of the air passages mentioned above or to all these passages. The latter option is preferred. Additionally or instead of applying the germicidal coating it is possible to use oligodynamically active substances as the material per se. In addition, springs, rods etc made of an oligodynamically effective material may be suspended in the air passages. By oligodynamic substances are meant metals or metal ions with a germicidal effect. A preferred example of such a substance is silver. However, the substances must be such that they will not irritate or damage the eye even at very low concentrations.

Atomisers and/or pump attachments thus equipped mean that there is no need to use preservatives in the formulations which are to be applied.

Preferred atomisers are those mentioned under point b).

In atomisers of this kind the atomising process is started by manual actuation of a pumping device. To equalise the pressure, air is able to flow into the storage container which is sterilised beforehand. The active substance formulation is preferably under normal pressure, there is no need to use overpressure.

Therefore, within the scope of the present invention, the atomiser should consist of a storage vessel and a pump attachment fitted thereon. The pump attachment preferably has the following features:

a seal for fitting on to the storage container in the form of a snap-fit, screwed or crimped closure;

a pump channel capable of pumping liquid out of the storage container into a pressure chamber

a valve in the pump channel which is provided between the storage vessel and the pressure chamber;

a riser tube which leads from the pressure chamber to a nozzle;

a pressure control valve in the riser tube.

a nozzle for atomising the liquid;

an actuating element by means of which a piston can be actuated which builds up the pressure required for atomisation in the pressure chamber;

air inlet points outside the pump tube or riser tube and air inlet passages from outside the pump attachment into the storage container;

oligodynamically effective substances in and/or along the pathway taken by the liquid in the pumping channel and/or riser tube between the storage container and nozzle;

means for sterilising along the path taken by the incoming air, i.e. between the air inlet openings and the storage container and

an adapter in the form of a cavity with two openings opposite each other, the smaller opening fitting snugly around at least the exit point of the aerosol from the nozzle and the larger opening having a contour which enables this opening to be placed over an eye.

This type of atomiser is in no way limiting to the present invention.

In the atomisers the formulated solutions are stored in a reservoir. The active substance formulations used have to have sufficient shelf life and at the same time be such that they can be administered directly for the medical purpose required, if possible without any further handling. Moreover, they should not contain any ingredients which could interact with the atomiser in such a way as to damage the atomiser or impair the pharmaceutical quality of the solution or of the aerosol produced. The adapter is a cavity surrounded by a wall with two openings. One opening surrounds the nozzle of the atomizer so that a spray jet leaving the nozzle is conveyed exclusively into the cavity. Preferably, the nozzle is centrally arranged within the opening. Through the second opening, which is generally opposite the first opening, the spray jet leaves the cavity to make contact with the eye. The outer contour of the second opening is preferably constructed so that it surrounds the visible part of the human eye, preferably without pressing on the surface of the eye.

To meet this criterion, this second opening is preferably of the following configuration, if the adapter is connected to the atomizer:

In plan view the openings of the adapter are round to oval in shape.

The opening closest to the eye is shaped so as to surround the eye entirely, i.e. one part of the opening is longer than the other. In cross section, the opening thus takes the form of a concave line one end of which is at a greater spacing from the nozzle than the other end.

In its simplest embodiment, the adapter is a funnel-shaped tube with two opposite openings, the opening on the tapering side surrounding the nozzle of the atomizer and thus being surrounded by the nozzle opening of the adapter. The opening on the other side of the adapter is large enough to fit round the outer contour of an eye.

The adapter may be permanently connected to the atomizer via the first opening, e.g. if the edge of this opening is welded onto part of the inhaler or if the casing of the atomizer and the adapter constitute a single component. The adapter is then an integral part of the atomizer and this first opening is then in practice only a non-open part of the atomizer.

The adapter may also be constructed as a detachable element.

The side of the adapter attached to the atomizer may be constructed so that it can be fitted directly onto the nozzle or is fixed to another element in the vicinity of the nozzle. For example, the adapter may be fitted to the nozzle of a conventional atomizer.

The other end of the adapter is constructed so that it can be placed on a person's face in such a way as to completely surround the visible part of the eye while covering as little of the skin of the face as possible. This ensures that the majority of the spray mist reaches the surface of the eye without wetting the facial skin very much. Preferably, the opening on this side of the adapter is oval.

On the outlet side of the adapter, openings may optionally be formed in the side wall of the adapter through which excess spray mist can escape. These openings preferably have a diameter of up to 1 cm, more preferably up to 0.5 cm.

Moreover, the adapter is designed so that it cannot damage the face or the eye.

### DESCRIPTION OF THE FIGURES

FIG. 1 shows a preferred atomiser (1) with pump attachment (2). The pump attachment (2) is firmly attached to the neck (102) of the storage bottle (101) via the snap-fit closure (3). The bottle (101) may consist of plastics, glass or metal, e.g. aluminium, but should be rigid enough so that the pump head can be moved without the bottle flexing. The inner edge of the snap fit closure (4) slides over the knurled edge of the bottle neck (102). Between the bottle neck and the pump attachment is a seal (5) which is made of rubber, natural rubber or synthetic rubber or preferably polyethylene, for example. A piston (6) with an axial pump channel (7) is located in the pressure cylinder (8). The piston (6) is held in its upper resting position by the spring (9) against a stop. The pressure chamber (10) is connected to the pump channel (7) and located between the piston (6) and the ball valve (11).

The piston (6) has a smaller external diameter than the internal diameter of the pressure cylinder (8), so that a gap (12) is left between the outer wall of the piston and the inner wall of the cylinder, which is sealed off by the peripheral sealing member (13) of the piston. In the lower region of the pressure chamber (10) the pressure cylinder (8) has a region (14) with a larger internal diameter in which the sealing member (13) does not have a sealing effect.

An actuating element (15) is provided on the piston (6). From there a riser tube (16) leads to a pressure control valve (17) in order to deliver the liquids which are to be atomised through the opening (18). In terms of their function the axial pump channel (7) and the riser tube (16) form a common riser tube which connects the pressure chamber with the nozzle. When the piston (6) is in the upper resting position, as shown in the drawings, the sealing member (13) seals the pressure chamber (10) off from the opening (19) of the storage container.

The piston rod (20) is firmly attached to the piston (6) in the region (21) and has a star-shaped diameter so as to leave a space between the pressure chamber (10) and the pump channel (7). In the resting position the piston rod (20) is remote from the ball valve (I 1), so that this valve is opened relative to the storage container when sufficient overpressure is generated in the pressure chamber (10) and the valve is closed when the pressure therein is low. The route travelled by the liquid from the storage container through the pump attachment is indicated by the arrow (22). When the ball valve (11) is open, the liquid passes through this valve and enters the pump channel (7). Thereafter it also passes through the open pressure control valve (17) and reaches the nozzle (18).

To avoid biological contamination of the liquid in the storage container, oligodynamically active substances are provided along the path travelled by the liquid from the storage chamber to the nozzle. These substances may be provided for example on the spring (9), on the wall of the pump channel (7), in the pressure control valve (17) and/or on the nozzle (18).

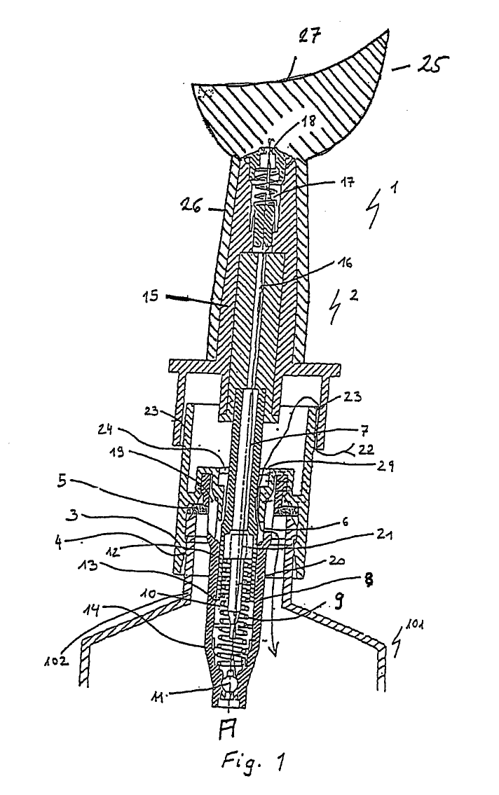

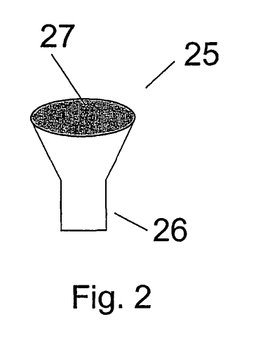

In order to equalise the pressure in the storage container (101) after the liquids have been expelled, air is able to flow into the device from the outside at the points (23) and then enter the storage container (101), as indicated for example by the arrow (22) in the drawing. Along the air passage, means are provided for sterilising the incoming air. These means include for example sterilising filters, membranes which are permeable only to air, materials which hold back bacteria, oligodynamically effective substances or microbicidally effective substances or combinations thereof. FIG. 1 shows a sterilising filter (24), for example.

As already mentioned, the pump attachment (2) is firmly attached to the bottle neck (102) by means of a snap-fit closure (3).

The adapter (25) is fitted on to the actuating element (15) so that the spray jet coming out of the nozzle (18) is guided directly into the widened part of the adapter. The lower part of the adapter (26) is releasably connected to the actuating element (15). The other end of the adapter (27) is constructed so that it can be placed like a negative over the area surrounding the eye.

The area (14) may merge, underneath the ball valve (11), into another pump channel which is only indicated (A) in FIG. 1. This pump channel then ends in the storage vessel.

FIG. 2 shows the adapter (25), again diagrammatically, the lower part (26) of which is fitted on to one or more projections arranged in a circular to oval configuration in the area around the nozzle or is fixedly connected thereto. The other end of the adapter, constructed as a negative of the area around the eye, is designated (27). The concave outer contour described above is not shown in any of the drawings.

The adapter may be designed so that the pulse of the particles of spray mist is reduced therein, and in particular the speed of the particles is reduced therein.

Most simply this is achieved by increasing the distance between the two openings of the adapter.

The atomizers described above are suitable for atomising the ophthalmological aerosol preparations to produce an aerosol suitable for administration to the eye.

Any known ophthalmologically active formulations are suitable as the formulation which may be administered using the atomizers according to the invention . These formulations may also differ from the prior art in that the active substances may be more highly concentrated if desired.

In the simplest case the formulation is, simply water (water for injections) or isotonic water or other agents for moistening the eye. In other words, there is no active substance present.

Suitable co-solvents may be, inter alia, ethanol, polyethyleneglycols, polypropyleneglycols, ethyleneglycols and propyleneglycols.

The active substances may be, for example, active substances selected from among the antibiotics and anti-infective agents, anticholinergics, antiglaucoma agents, antimycotics, antiseptics, anaesthetics, eye tonics, corticoids and steroids, film-forming agents, vaso-active substances, homoeopathic medicines, mydriatics, NSAID (antiphlogistics), prostaglandins, artificial tears, vitamins and/or virostatics.

Furthermore, any pharmacologically and ophthalmologically acceptable pharmaceutical excipients may be added to the formulations. These include inter alia arufil, benzalkonium chloride, boric acid, calcium chloride, carbomer, chlorhexidine digluconate, citric acid, EDTA, edetic acid salts; glucose, glutathione disulphide, hydroxyethylcellulose, hypromellose, potassium chloride, magnesium chloride, magnesium sulphate, magrocol, mannitol, sodium acetate, sodium chloride, sodium dihydrogen phosphate, sodium hydrogen carbonate, sodium hydroxide, sodium monohydrogen phosphate, sodium tetraborate, sodium thiosulphate, phenylmercury borate, polyethylene oxide, polyoxyethylene-polyoxypropylene copolymer, polysorbate, polyvinyl alcohol, povidone, hydrochloric acid, sorbitol, thiomersal and tyloxapol.

As already mentioned a number of times, with the atomizers according to the invention the addition of preservatives such as EDTA, benzalkonium chloride and others can be and preferably is omitted.

Among the advantages of the process according to the invention are the fact that:

the irritation to the cornea or the conjunctival tissue of the eye is reduced when formulations are administered to the eye in this manner;

ophthalmological formulations are applied uniformly to the surface of the eye, thereby improving absorption by the cornea or the conjunctiva;

there is no need to add any preservatives;

thanks to the active pumping mechanism and the moving spray mist thus produced there is no need to recline the head when administering the medicament;

each spray actuation is carried out consciously by a pumping movement, so that the patient knows how many actuations have been done, so that

the dosage can be reproduced very exactly;

the amount delivered is comparatively small;

overdosing is avoided;

systemic side effects are reduced as a result of the small amount applied;

there is no need to squeeze the storage bottle in order to initiate the spray jet, i.e. there is less risk of the applicator being accidentally pressed into the eye.

What is claimed is:

1. Propellant-free atomizer for administering liquids to the cornea or conjunctiva of the human eye, containing:
a storage vessel for the liquid which is to be applied
a pump attachment on the storage vessel;
a seal on the pump attachment for fitting onto the storage container, for example in the form of a snap-fit, screwed or crimped closure,
a pump channel which is able to pump liquid from the storage container into a pressure chamber;
a valve in the pump channel which is provided between the storage vessel and pressure chamber;
a riser tube which leads from the pressure chamber to a nozzle;
a pressure control valve in the riser tube;
a nozzle for atomising the liquid;
an actuating element by means of which a piston can be actuated which builds up the pressure in the pressure chamber needed for the atomisation;
air inlet points outside the pump tube or riser tube and air inlet passages from outside the pump attachment into the storage container;
oligodynamically effective substances in and/or along the path taken by the liquid in the pump channel and/or riser tube between the storage container and nozzle;
means for sterilising along the path taken by the inflowing air and an adapter according to one of the preceding claims which is formed at the tip of the pump attachment, and
an adapter in the form of a cavity with two openings surrounded by a wall, wherein
one opening surrounds the nozzle in such a way that a jet spray emerging therefrom is conveyed exclusively into the cavity and
the second opening, which is opposite the first, has an outer contour which is such that the opening surrounds the visible part of the eye of a person or animal without directly touching the eye.

2. Atomizer according to claim 1, characterised in that the outer contour of the second opening of the adapter is oval in plan view and in cross section takes the form of a concave curved line with a longer end and a shorter end.

3. Atomizer according to claim 1, characterised in that the adapter is indivisibly attached to the atomizer as an integral part thereof.

4. Atomizer according to claim 1, characterised in that the adapter is fitted onto the nozzle.

5. Atomizer according to claim 1, characterised in that the attachment with the nozzle is a pumping system.

6. Atomizer according to claim 1, characterised in that the means for sterilising along the path taken by the inflowing air are filters for microbiological germs or filters with a germicidal activity.

7. Atomizer according to claim 1, characterised in that openings are provided in the side wall of the adapter.

8. Adapter for an atomizer for administering liquid to the cornea or conjunctiva of the human eye according to claim 1.
